(19) United States
(12) Patent Application Publication
(10) Pub. No.: US 2014/0129854 A1
(43) Pub. Date: May 8, 2014

(54) Auto-Negotiation and Advanced Classification for Power Over Ethernet (POE) Systems

(71) Applicant: Broadcom Corporation, Irvine, CA (US)

(72) Inventor: Wael DIAB, San Francisco, CA (US)

(73) Assignee: Broadcom Corporation, Irvine, CA (US)

(21) Appl. No.: 14/074,324

(22) Filed: Nov. 7, 2013

Related U.S. Application Data
(60) Provisional application No. 61/723,503, filed on Nov. 7, 2012.

(51) Int. Cl. G06F 1/26

(52) U.S. Cl. CPC G06F 1/266
USPC 713/310

(57) ABSTRACT

Systems and methods are provided for an auto-negotiation mode of operation that allows power source equipment (PSE) and a powered device (PD) to negotiate power transfer and/or data communication without the use of conventional classification pulses. The auto-negotiation mode of operation provides for a universal negotiation of information between the PSE and PD regardless of the specific capabilities of each. The information can be used to configure the power to be applied to the communication link and/or data communication over the communication link.

### CROSS REFERENCE TO RELATED APPLICATIONS

This application claims the benefit of U.S. Provisional Patent Application No. 61/723,503, filed on Nov. 7, 2012, which is incorporated by reference herein in its entirety.

### FIELD OF THE INVENTION

This disclosure relates to Power over Ethernet (PoE) and more specifically to auto-negotiation for PoE systems.

### BACKGROUND

Ethernet communication provides high speed data communication over a communication link between two communication nodes that operate according to an Institute of Electrical and Electronics Engineers (IEEE) 802 Ethernet Standard. Power over Ethernet (PoE) communication systems provide power and data communication over the common communication link. More specifically, a conventional power source equipment (PSE)) at a first node of the communication link provides DC power to a conventional powered device (PD) at a second node of the communication link. The DC power is transmitted simultaneously over the communication link with the high speed data. Conventionally, the communication link can be a category 3 cable or a category 5 cable having multiple twisted pairs of conductors. The original IEEE 802.3af™ standard provides up to 15.4 W of DC power (minimum 44 V DC and 350 mA) to each PD over two-pairs of conductors. The updated IEEE 802.3at™ standard, also known as PoE+, provides up to 25.5 W of power to each PD over two-pairs of conductors.

Before providing the DC power over the communication link, the conventional PSE can perform a conventional detection process to determine whether a device is a PoE-enabled conventional PD. After determining the device is a PoE-enabled conventional PD, the conventional PSE performs a conventional classification process to classify the conventional PD in terms of ranges of power usage. For example, the conventional PSE provides a series of conventional classification pulses between 14.5 V to 20.5 V to the communication link to determine power usage of the conventional PD to classify an IEEE 802.3af conventional PD.

As future PoE standards allow for more DC power, and hence more classifications, to be supplied over the communication link, additional conventional classification pulses may be required to classify these future devices. Additionally, manufacturers have begun to offer PoE solutions that utilize all four pairs of the conductors of the communication link to provide up to 51 W of power instead of 25.5 W over two-pairs of conductors as outlined in the IEEE 802.3at™ standard. Additional conventional classification pulses will likely be needed to differentiate between four-pair and two-pair PD devices. Further, manufacturers have begun to offer PoE solutions in new environments, such as an automotive environment or an industrial environment to provide some examples. These new environments can have new features that can be environment specific which will require even more conventional classification pulses to differentiate between environments.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 is a block diagram of a Power over Ethernet (PoE) system.

FIG. 2 is a diagram illustrating power transfer from Power Source Equipment (PSE) to a Powered Device (PD) in a PoE communication system in accordance with an embodiment of the present disclosure.

FIG. 3 illustrates exemplary profile information 302 that can be used in accordance with an embodiment of the present disclosure.

FIG. 4 is a block diagram of an exemplary PSE controller 218 and an exemplary PD controller 228 in accordance with an embodiment of the present disclosure.

FIG. 5 is a flowchart of an exemplary method for passive auto-negotiation in accordance with an embodiment of the present disclosure.

FIG. 6 is a flowchart of an exemplary method for active auto-negotiation in accordance with an embodiment of the present disclosure.

FIG. 7 is a flowchart of an exemplary method for active auto-negotiation performed by a PD in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described can include a particular feature, structure, or characteristic, but every exemplary embodiment can not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications can be made to the exemplary embodiments within the spirit and scope of the disclosure. Therefore, the Detailed Description is not meant to limit the disclosure.

Embodiments of the disclosure can be implemented in hardware, firmware, software, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing device). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software, routines, instructions can be described herein as performing certain actions. However, it should be appreciated that such descriptions are merely for convenience and that such actions in fact result from computing devices, processors, controllers, or other devices executing the firmware, software, routines, instructions, etc.

The following Detailed Description of the exemplary embodiments will so fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

For purposes of this discussion, the term “module” shall be understood to include at least one of software, firmware, and hardware (such as one or more circuits, microchips, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

### 1. OVERVIEW

The present disclosure describes an auto-negotiation, also referred to as an enhanced classification, mode of operation that allows power source equipment (PSE) and a powered device (PD) to negotiate power transfer and/or data communication without the use of the conventional classification pulses. The auto-negotiation mode of operation allows the PSE and the PD to exchange information before the PSE applies power over the communication link. The information can be used to configure the power to be applied to the communication link and/or data communication over the communication link. The auto-negotiation mode of operation provides for a universal negotiation of the information between the PSE and PD regardless of the specific capabilities of each.

### 2. PoE SYSTEMS

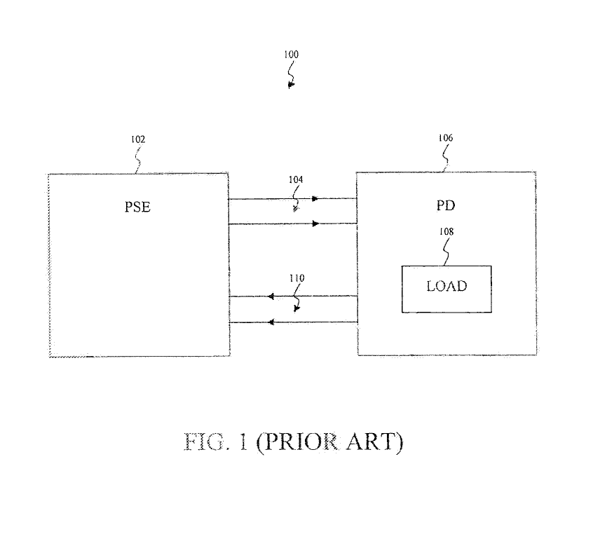

FIG. 1 is a block diagram of a Power over Ethernet (PoE) system. More specifically, FIG. 1 illustrates a high level diagram of a Power over Ethernet (PoE) system 100 that provides both DC power and data communication over a common data communication link. Referring to FIG. 1, the power source equipment (PSE) 102 provides DC power over conductors 104, 110 to a powered device (PD) 106 having a representative electrical load 108. The conductors 104, 110 can be multiple pairs, such as two or four to provide some examples, of a category 5 cable for Ethernet, or other types of communication links that are appropriate. The PSE 102 provides PoE according to a known PoE standard, such as the IEEE 802.3af™ standard, the IEEE 802.3at™ standard, the updated IEEE 802.3at™ standard, the IEEE 802.3™ standard, a legacy PoE transmission, and/or any suitable type of PoE transmission standard to provide some examples. The PSE 102 and the PD 106 also include data transceivers that operate according to a known communication standard, such as a 100BASE-T, a 100BASE-TX, a 1000BASE-T, a 10GBASE-T, and/or any other suitable communication standard to provide some examples. More specifically, the PSE 102 includes a physical layer device on the PSE side that transmits and receives high speed data with a corresponding physical layer device in the PD 106. Accordingly, the power transfer between the PSE 102 and the PD 106 occurs simultaneously with the exchange of high speed data over the conductors 104, 110.

The conductors 104, 110 can carry high speed differential data communication. In one example, the conductors 104, 110 each include one or more twisted wire pairs, or any other type of cable or communication media capable of carrying the data transmissions and DC power transmissions between the PSE 102 and the PD 106. In Ethernet communication, the conductors 104, 110 can include multiple twisted pairs, for example four-pairs of conductors for 10GBASE-T. In 10/100 Ethernet, only two-pairs of the four-pairs of conductors carry data communication, and the other two-pairs of conductors are unused for data communication, but can be used to transfer power. Herein, conductor pairs may be referred to as Ethernet cables or communication links for ease of discussion.

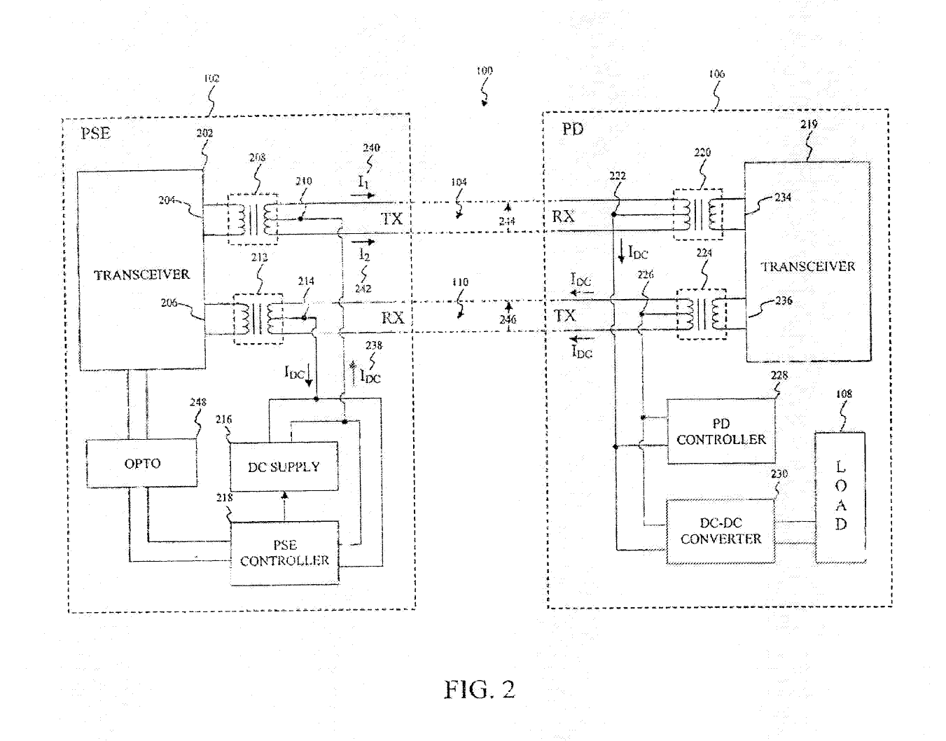

FIG. 2 is a diagram illustrating power transfer from Power Source Equipment (PSE) to a Powered Device (PD) in a PoE communication system in accordance with an embodiment of the present disclosure. FIG. 2 provides a more detailed circuit diagram of the PoE system 100, where PSE 102 provides DC power to PD 106 over conductor pairs 104 and 110. PSE 102 includes a transceiver physical layer device (or PHY) 202 having full duplex transmit and receive capability through differential transmit port 204 and differential receive port 206. (Herein, transceivers may be referred to as PHYs). A first transformer 208 couples high speed data between the transmit port 204 and the first conductor pair 104. Likewise, a second transformer 212 couples high speed data between the receive port 206 and the second conductor pair 110. The respective transformers 208 and 212 pass the high speed data to and from the transceiver PHY 202, but isolate any low frequency or DC voltage from the transceiver ports, which may be sensitive large voltage values.

The first transformer 208 includes primary and secondary windings, where the secondary winding includes a center tap 210. Likewise, the second transformer 212 includes primary and secondary windings, where the secondary winding includes a center tap 214. The DC voltage supply 216 generates an output voltage that is applied across the respective center taps of the transformers 208 and 210 on the conductor side of the transformers. The center tap 210 is connected to a first output of a DC voltage supply 216, and the center tap 214 is connected to a second output of the DC voltage supply 216. As such, the transformers 208 and 212 isolate the DC voltage from the DC supply 216 from the sensitive data ports 204, 206 of the transceiver PHY 202. An example DC output voltage is 48 volts, but other voltages could be used depending on the voltage/power requirements of the PD 106.

The PSE 102 further includes a PSE controller 218 that controls the DC voltage supply 216 based on the dynamic needs of the PD 106. More specifically, the PSE controller 218 measures voltage, current, and temperature of the outgoing and incoming DC supply lines so as to characterize the power requirements of the PD 106.

Further, the PSE controller 218 detects and validates a compatible PD, determines a power classification signature for the validated PD, supplies power to the PD, monitors the power, and reduces or removes the power from the PD when the power is no longer requested or required. During detection, if the PSE finds the PD to be non-compatible, the PSE can prevent the application of power to that PD device, protecting the PD from possible damage. IEEE has imposed standards on the detection, power classification, and monitoring of a PD by a PSE in the IEEE 802.3af™ standard, which is incorporated herein by reference.

Still referring to FIG. 2, the contents and functionality of the PD 106 will now be discussed. The PD 106 includes a transceiver physical layer device (or PHY) 219 having full duplex transmit and receive capability through differential transmit port 236 and differential receive port 234. A third transformer 220 couples high speed data between the first conductor pair 104 and the receive port 234. Likewise, a fourth transformer 224 couples high speed data between the transmit port 236 and the second conductor pair 110. The respective transformers 220 and 224 pass the high speed data to and from the transceiver PHY 219, but isolate any low frequency or DC voltage from the sensitive transceiver data ports.

The third transformer 220 includes primary and secondary windings, where the secondary winding (on the conductor side) includes a center tap 222. Likewise, the fourth transformer 224 includes primary and secondary windings, where the secondary winding (on the conductor side) includes a center tap 226. The center taps 222 and 226 supply the DC power carried over conductors 104 and 110 to the representative load 108 of the PD 106, where the load 108 represents the dynamic power draw needed to operate PD 106. A DC-DC converter 230 may be optionally inserted before the load 108 to step down the voltage as necessary to meet the voltage requirements of the PD 106. Further, multiple DC-DC converters 230 may be arrayed in parallel to output multiple different voltages (3 volts, 5 volts, 12 volts) to supply different loads 108 of the PD 106.

The PD 106 further includes a PD controller 228 that monitors the voltage and current on the PD side of the PoE configuration. The PD controller 228 further provides the necessary impedance signatures on the return conductor 110 during initialization, so that the PSE controller 218 will recognize the PD as a valid PoE device, and be able to classify its power requirements.

During ideal operation, a direct current (IDC) 238 flows from the DC power supply 216 through the first center tap 210, and divides into a first current (I1) 240 and a second current (I2) 242 that is carried over conductor pair 104. The first current (I1) 240 and the second current (I2) 242 then recombine at the third center tap 222 to reform the direct current (IDC) 238 so as to power PD 106. On return, the direct current (IDC) 238 flows from PD 106 through the fourth center tap 226, and divides for transport over conductor pair 110. The return DC current recombines at the second center tap 214, and returns to the DC power supply 216. As discussed above, data transmission between the PSE 102 and the PD 106 occurs simultaneously with the DC power supply described above. Accordingly, a first communication signal 244 and/or a second communication signal 246 are simultaneously differentially carried via the conductor pairs 104 and 110 between the PSE 102 and the PD 106. It is important to note that the communication signals 244 and 246 are differential signals that ideally are not affected by the DC power transfer.

### 3. CONVENTIONAL CLASSIFICATION AND DETECTION IN PoE SYSTEMS

In an exemplary embodiment, the conventional PSE can perform a conventional detection process to determine whether a device (e.g., conventional PD) is PoE-enabled before providing the DC power over a communication link. During the conventional detection process, the conventional PSE can provide a small current-limited voltage between 2.7 V to 10.1 V over the communication link while measuring a load, also referred to as a signature, applied by conventional PD. When the signature of the conventional PD is within a pre-defined range of resistance and capacitance, typically between 19-26.5 kΩ for IEEE 802.3af™ and IEEE 802.3at™ standard compliant devices, the conventional PD is detected by the conventional PSE to be PoE-enabled, namely a PD.

After determining that the conventional PD qualifies as a PD, the conventional PSE performs a conventional classification process to classify the conventional PD in terms of ranges of power usage. To classify an IEEE 802.3af PD, the conventional PSE provides a series of conventional classification pulses between 14.5 V to 20.5 V to the communication link to determine power usage of the conventional PD. The 15.4 W of power that is capable of being provided in accordance with the IEEE 802.3af™ standard is separated into various power ranges, with each power range corresponding to a class of PD, such as class 0, class 1, class 2, and class 3. The 25.5 W that is capable of being provided in accordance with the IEEE 802.3at™ standard is also separated into various power ranges with each power range corresponding to class 0, class 1, class 2, class 3, or class 4.

To classify an IEEE 802.3af™ standard compliant PD, the conventional PSE provides a first conventional classification pulse to measure the resistance of the conventional PD. The conventional PSE receives a response to the first conventional classification pulse which indicates the power usage of the conventional PD. The conventional PSE can then classify the conventional PD as being class 0, class 1, class 2, or class 3, depending upon the power usage of the conventional PD. To classify an IEEE 802.3at™ standard complaint PD, the conventional PSE provides a second conventional classification pulse after receiving the response to the first conventional classification pulse. The conventional PSE receives a response to the second conventional classification pulse which indicates the conventional PD is class 4.

As illustrated by the classification processes described above, conventional classification processes can require transmission of several pulses during classification. As future PoE standards allow for more capabilities within a PoE system, more classification pulses are required to classify these future devices to identify their capabilities.

### 4.1 Auto-Negotiation Mode of Operation

Embodiments of the present disclosure provide systems and methods for auto-negotiation in a PoE system (e.g., in PoE system 100). Auto-negotiation, also referred to as an enhanced classification, is a mode of operation that allows the PSE 102 and the PD 106 to negotiate power transfer and/or data communication. In an exemplary embodiment, the classification is performed without the use of the conventional classification pulses. In another exemplary embodiment, the classification can be performed using a combination of a relatively limited number of the conventional classification pulses and the auto-negotiation mode of operation.

The auto-negotiation mode of operation allows the PSE 102 and the PD 106 to exchange information before the PSE 102 applies the power over the communication link (e.g., over conductors 104, 110). The information can be used to configure the power to be applied to the communication link and/or data communication over the communication link. The auto-negotiation mode of operation provides for a universal negotiation of the information between the PSE 102 and the PD 106 regardless of the specific capabilities of each. This allows manufacturers to combine and to market PoE solutions with various levels and/or types of PoE functionality. For example, manufacturers can easily mix and match a PSE with PDs of varying functionality to allow the manufacturers to economically offer various PoE solutions models having differing levels of PoE functionality. Accordingly, the auto-negotiation mode of operation enables manufacturers to economically leverage their existing system architectures and offer several product variations for different market segments.

In an exemplary embodiment, the PSE 102 can perform the conventional detection process to determine whether the PD 106 is PoE-enabled before providing the power over the communication link and then operate in the auto-negotiation mode of operation to configure the power to be applied and/or data communication over the conductors 104, 110. Otherwise, the PSE 102 can operate in the auto-negotiation mode of operation to determine whether the PD 106 is PoE-enabled as well as configure the power to be applied and/or data communication over the conductors 104, 110.

Generally, the information exchanged in the auto-negotiation mode of operation relates to the power transferring and/or data communicating capabilities of the PSE 102 and/or the PD 106. For example, the PD 106 can provide its power transferring and/or data communicating capabilities to the PSE 102, which configures the power to be applied and/or the data communication over the conductors 104, 110 to operate within the capabilities of the PD 106. As another example, the PSE 102 can provide its power transferring and/or data communicating capabilities to the PD 106, which selects from among these capabilities in accordance with its own capabilities. In this other example, the PD 106 can provide the selected capabilities to the PSE 102 which configures the power to be applied and/or the data communication over the conductors 104, 110.

In an exemplary embodiment, the PSE 102 and/or the PD 106 exchange profile information during the auto-negotiation mode of operation. Based on this profile information, the PSE 102 can configure the power to be applied over the conductors 104, 110 to the PD 106 (e.g., based on standards supported by the PSE 102 and/or the PD 106). Profile information can be exchanged in a passive auto-negotiation mode of operation and/or an active auto-negotiation mode of operation. In the passive mode of operation, the PSE 102 determines profile information of the PD 106 by applying impulses over conductors 104, 110 specifically tailored to generate a response by the PD 106 and measuring these responses. In the active mode of operation, the PSE 102 applies a minimal amount of power over the conductors 104, 110 to power the PD 106, and the PD 106 provides profile information to the PSE 102 after being powered up.

Using these auto-negotiation modes, different variations of possible auto-negotiation for PoE applications can be covered. These variations can include, but are not limited to, physical layer signaling, layer 2 auto-negotiation, and expanded auto-negotiation to stage the availability of features (e.g., basic powering followed by advance feature availability through the physical layer exchange, layer 2, and/or data plane negotiation). Exemplary profile information exchange and passive and active auto-negotiation modes in accordance with an embodiment of the present disclosure will now be described in greater detail.

### 4.2 Profile Information

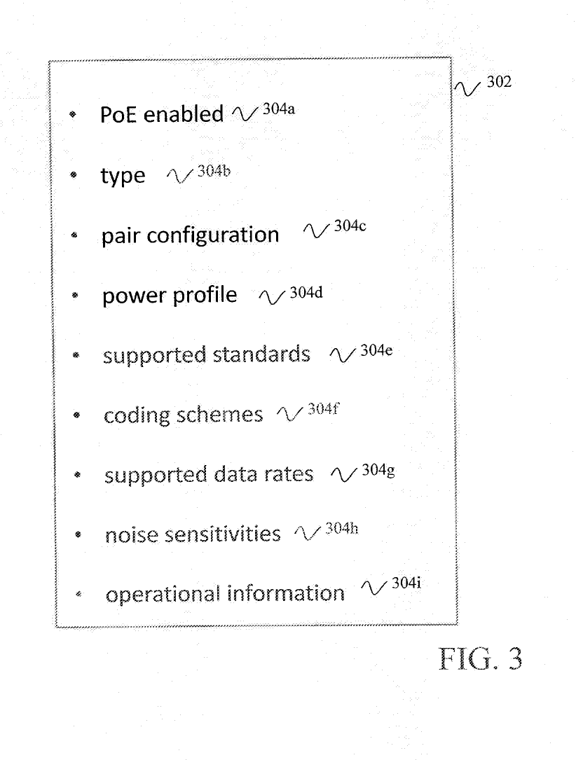

The information exchanged in the auto-negotiation mode of operation can include, but is not limited to, a profile of the PSE 102 and/or of the PD 106 that can be used to configure the power to be applied and/or the data communication over the conductors 104, 110. This profile can include features of the PSE 102 and/or of the PD 106 that relate to the transfer of power over the conductors 104, 110. FIG. 3 illustrates exemplary profile information 302 that can be used in accordance with an embodiment of the present disclosure. As shown by FIG. 3, profile information 302 can include several features 304. For example, these features can include PoE enabled information 304a indicating whether the PD 106 is PoE-enabled. These features can also include a “type” 304b of the PSE 102 and/or of the PD 106, pair configuration information 304c, power profile information 304d (e.g., power providing capabilities PoE standards which are supported by the PSE 102 and/or the PD 106). These features can also include information regarding supported standards 304e (e.g., whether the PSE 102 and/or the PD 106 support the IEEE 802.3af standard, the IEEE 802.3at™ standard, the updated IEEE 802.3at™ standard, the IEEE 802.3™ standard, a legacy PoE transmission, and/or other suitable type of PoE transmission standard). These features can further include coding scheme information 304f, supported data rate information 304g, noise sensitivity information 304h, and/or operations information 304i.

It should be understood that these exemplary features 304 are provided by way of example and are not limiting. One of ordinary skill in the art will understand that a variety of features can be used in a profile information exchange in accordance with an embodiment of the present disclosure. Exemplary features 304 will now be described in greater detail.

In an exemplary embodiment, the “type” 304b of the PSE 102 and/or of the PD 106 can indicate which standards the PSE 102 and/or the PD 106 are compliant with. For example, in an embodiment, a “type 1” device can be compliant with the IEEE 802.3af™ standard, a “type 2” device can be compliant with the IEEE 802.3at™, and a “type 3” device can be compliant with the updated IEEE 802.3at™ standard. However, other types may be possible for the PSE 102 and the PD 106 to indicate compliance with other known PoE standards.

In an exemplary embodiment, pair configuration information 304c can indicate of whether the PSE 102 and/or the PD 106 are capable of operating in a two-pair and/or a four-pair configuration for transferring power and/or communicating data and optionally which pairs from among the two-pair and the four-pair configurations are to be used for transferring power and/or communicating data. Power profile information 304d can indicate, for example, power providing capabilities of the PSE 102 and/or a power profile of the PD 106, such as its power requirements. In an exemplary embodiment, the power profile information 304d can include parameters that are specific to the power itself, such as voltage and/or current levels.

In an exemplary embodiment, supported standard information 304e can include features of the PSE 102 and/or of the PD 106 that relate to the data communication over the conductors 104, 110. For example, supported standard information 304e can indicate whether the PSE 102 and/or the PD 106 support the 10BASE-T, the 100BASE-TX, the 1000BASE-T, the GBASE-T, and/or any other suitable communication standard.

In an exemplary embodiment, coding scheme information 304f can indicate coding schemes for the data communication which are supported by the PSE 102 and/or the PD 106. For example, coding scheme information 304f can indicate whether the PSE 102 and/or the PD 106 support various multi-level transmit (MLT) coding and/or various pulse amplitude modulation (PAM) coding to provide some examples.

In an exemplary embodiment, supported data rate information 304g can indicate data rates for the data communication which are supported by the PSE 102 and/or the PD 106. In an exemplary embodiment, noise sensitivity information 304h can indicate noise sensitivities of the PSE 102 and/or the PD 106. Different applications have varying sensitivity to interference from noise sources depending upon their capabilities. For example, 10 GBASE-T is commonly recognized to be extremely sensitive to crosstalk. The features can yet further include an indication of which pair or pairs of the communication link are to be used for the data communication.

In an exemplary embodiment, operational information 304i can indicate features of the PSE 102 and/or of the PD 106 that relate to operational aspects of the PSE 102 and/or of the PD 106. For example, operational information 304i can indicate operational environments, such as an automotive environment, an industrial environment, an enterprise environment, or any other suitable environment, which are supported by the PSE 102 and/or the PD 106. Operational information 304i can indicate functions that are available to the PSE 102 and/or the PD 106. For example, the PSE 102 and/or the PD 106 can be implemented as part of an IP security camera; a network router; a network webcam; a network intercom/paging/public address system; a VoIP phone; a wireless access point; an industrial or automotive device, such as a sensor, a controller, and/or a meter to provide some examples; an access control and help-point system, such as an intercom, an entry card, and/or a keyless entry to provide some examples; a lighting controller; a Point of Sale (POS) kiosk; a physical security device and controller; or any other suitable device. In this example, the profile of the PSE 102 and/or of the PD 106 the PSE 102 and/or the PD 106 can include functions of these devices.

### 4.3 Passive Auto-Negotiation Mode

In an exemplary embodiment, the PSE 102 and the PD 106 can exchange the profile information 302 in a passive auto-negotiation mode of operation and/or an active auto-negotiation mode of operation. In an exemplary embodiment, the passive auto-negotiation mode of operation represents a physical layer signaling, also referred to as layer 1 signaling. In the passive auto-negotiation mode of operation, the PSE 102 can apply various impulses to the communication link and measure a response of the PD 106 to these various impulses to determine the information. In an exemplary embodiment, the PSE 102 can provide one or more impulses over the conductors 104, 110 that are specifically tailored to cause a specific response by the PD 106 that can be used by the PSE 102 to determine the profile of the PD 106.

For example, in an exemplary passive auto-negotiation mode, the PSE 102 can first determine whether the PD 106 qualifies as a PD. For example, the PSE 102 can provide a small current-limited voltage between 2.7 V to 10.1 V over conductors 104, 110 while measuring a load, also referred to as a signature, applied by PD 106. When the signature of the PD 106 is within a pre-defined range of resistance and capacitance, typically between 19-26.5 kRf for IEEE 802.3af™ and IEEE 802.3at™ standard compliant devices, the PD 106 is detected by the PSE 102 to be PoE-enabled, namely a PD.

After determining that the PD 106 qualifies as a PD, the PSE 102 can send an impulse over conductors 104, 110 that is specifically tailored to cause PD 106 to generate a specific response that can be used by the PSE 102 to determine the profile of the PD 106. In an exemplary embodiment, the PSE 102 can be configured to generate impulses that can cause the PD 106 to respond with information characterizing the PD 106 for all variations of possible auto-negotiation for PoE applications. Based on the responses from the PD 106, the PSE 102 can generate a profile characterizing the PD 106 and can determine how to configure the power to be applied and/or the data communication over the conductors 104, 110.

In an exemplary embodiment, PSE 102 can be configured to send an impulse over conductors 104, 110 that is specifically tailored to cause PD 106 to generate a specific response usable by the PSE 102 to determine the profile of the PD 106 in a variety of ways. For example, in an embodiment, PSE 102 can determine whether PD 106 uses four pairs or two pairs of conductors 104, 110 by sending data over all four pairs and waiting for a response. If PD 106 sends data back over two pairs only, PSE 102 can determine that PD 106 uses two pairs of conductors 104, 110. If PD 106 sends data back over all four pairs, PSE 102 can determine that PD 106 uses four pairs of conductors 104, 110. In an embodiment, PSE 102 can determine profile characteristics of PD 106 in a variety of ways based on sending data to PD 106 and analyzing a response from PD 106. Based on these responses, PD 106 can determine one or more features 304 of profile information 302 for PD 106.

### 4.4 Active Auto-Negotiation Mode

In an exemplary embodiment, the active auto-negotiation mode of operation represents data link layer signaling, also referred to as layer 2 signaling. In the active auto-negotiation mode of operation, the PSE 102 applies a minimal amount of power over the conductors 104, 110 to activate the PD 106. This minimal amount of power is less than the power to be applied over the conductors 104, 110 and is sufficiently small to not damage the PD 106. In an exemplary embodiment, the PSE 102 can apply a burst of energy over the conductors 104, 110 to allow the PD 106 to derive or harvest power from the burst of energy. In this alternative, the PD 106 can include a simple capacitor to store the burst of energy or a rectifier and/or a regulator to derive or harvest power from the burst of energy.

In the active auto-negotiation mode of operation, the PD 106 responds to impulses generated by the PSE 102 based on its profile information 302. For example, the PD 106 can provide the information to the PSE 102 using an expansion of the Layer 2 Link Layer Discovery Protocol (LLDP)/Dynamic Link Layer (DLL) protocols once powered. In an exemplary embodiment, the PD 106 can provide information to the PSE 102 for all variations of possible auto-negotiation for PoE applications. Based on the information from the PD 106, the PSE 102 can generate a profile characterizing the PD 106 and can determine how to configure the power to be applied and/or the data communication over the conductors 104, 110.

In an exemplary embodiment, PSE 102 can generate a profile characterizing the PD 106 in a variety of ways. For example, in an exemplary embodiment, PSE 102 can send one or more packets of data to PD 106 to query one or more features 304 of profile information 302 for PD 106. PD 106 can respond with packets of data containing information regarding these one or more features 304 of profile information 302 for PD 106. Based on this information, PSE 102 can generate a profile characterizing the PD 106 and can determine how to configure the power to be applied and/or the data communication over the conductors 104, 110.

In another exemplary embodiment, PSE 102 can be configured to store a dictionary of impulses that can be used to classify a variety of PD's. PSE 102 can send an impulse to PD 106, and based on the response from PD 106, PSE 102 can determine a next impulse to be sent to PD 106 until PSE 102 sends an appropriate impulse to classify PD 106. In an exemplary embodiment, PSE 102 can be updated to generate new impulses used by new PD's as new PD's are manufactured and as new standards are created.

### 4.5 Exemplary PSE Controller and PD Controller

In an exemplary embodiment, PSE controller 218 and/or PD controller 228 can be implemented using hardware, software, or a combination of hardware and software. PSE controller 218 and/or PD controller 228 can be implemented using one or more integrated circuits (ICs). In an exemplary embodiment, PSE controller 218 is implemented using a single IC, and PD controller 228 is implemented using a single IC. In an exemplary embodiment, PSE controller 218 and/or PD controller 228 can include one or more processors and/or memories.

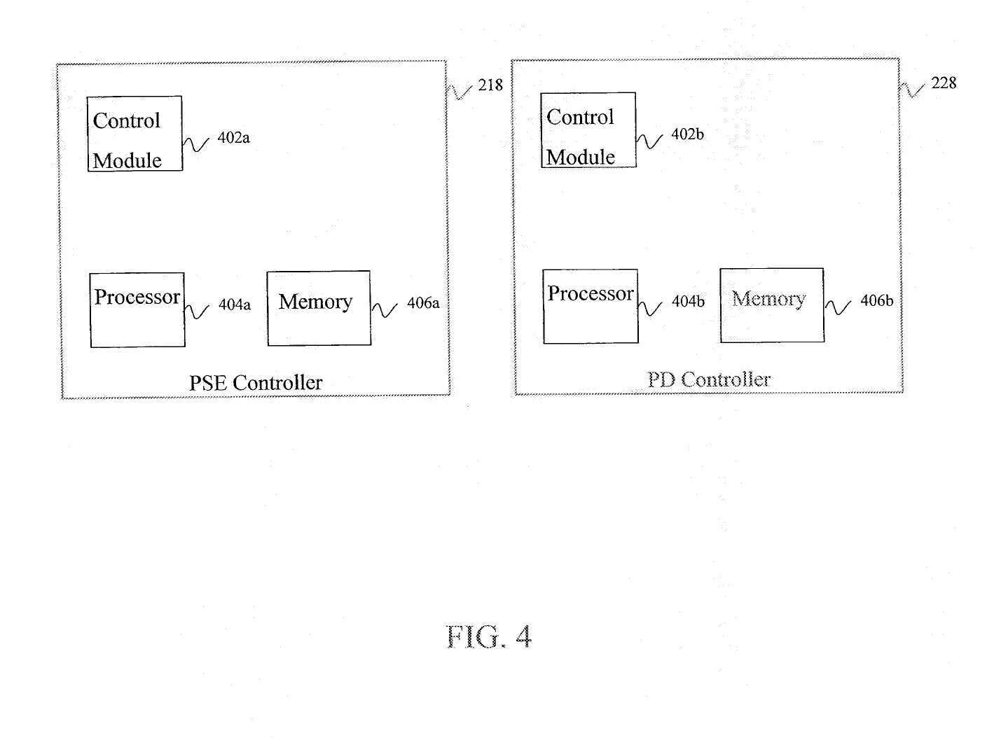

FIG. 4 is a block diagram of an exemplary PSE controller 218 and an exemplary PD controller 228 in accordance with an embodiment of the present disclosure. As shown in FIG. 4, PSE controller 218 can include a control module 402a, a processor 404a, and a memory 406a. PD controller 228 can also include a control module 402b, a processor 404b, and a memory 406b. In an exemplary embodiment, PSE controller 218 and/or PD controller 228 do not include internal processors 404 or memories 406 but instead access processors and/or memories external to PSE controller 218 and/or PD controller 228.

In an exemplary embodiment, control modules 402 can be used to control the operation of PSE controller 218 and/or PD 228. For example, control modules 402 can be used to exchange profile information 302. In an exemplary embodiment, processors 404 can be used to process profile information 302. In an exemplary embodiment, memories 406 can be used to store profile information 302. For example, in an embodiment, as PSE controller 218 determines profile information 302 of PD 228, control module 402a can build a profile of PD 228 and can store profile information 302 of PD 228 in memory 406a. Control modules 402 can be implemented using hardware, software, or a combination of hardware and software, and, in an embodiment, control modules 402 can be implemented using one or more ICs.

### 5. AUTO-NEGOTIATION METHODS

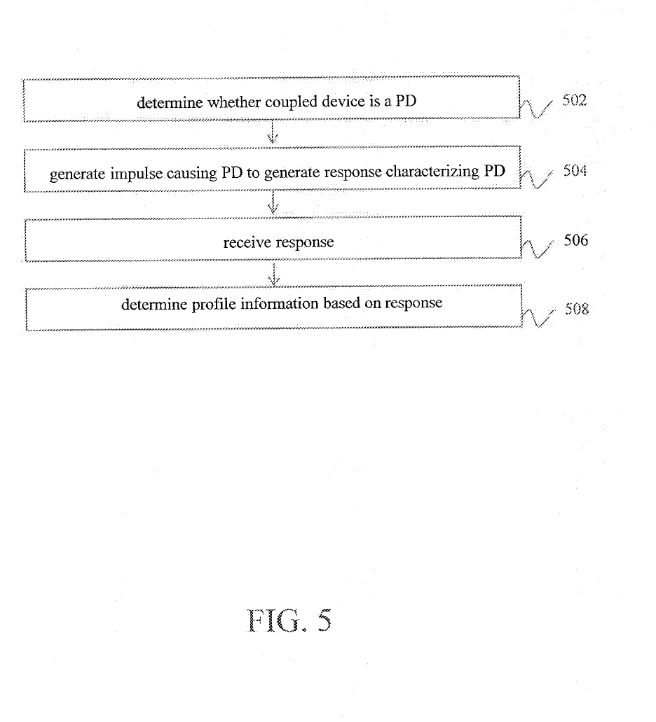

FIG. 5 is a flowchart of an exemplary method for passive auto-negotiation in accordance with an embodiment of the present disclosure. In step 502, the PSE 102 determines whether the PD 106 qualifies as a PD. If the PSE 102 determines that the PD 106 does not qualify as a PD, the PSE 102 can stop trying to classify the PD and/or, in an embodiment, determine that power should not be supplied.

In step 504, once the PSE 102 determines that the PD 106 qualifies as a PD, the PSE 102 generates an impulse causing the PD 106 to generate a response characterizing the PD 106. In an exemplary embodiment, the PSE 102 can be configured to generate impulses that can cause the PD 106 to respond with information characterizing the PD 106 for all variations of possible auto-negotiation for PoE applications. In step 506, the PSE 102 receives the response from the PD 106. In step 508, based on the responses from the PD 106, the PSE 102 can generate a profile characterizing the PD 106 and can determine how to configure the power to be applied and/or the data communication over the conductors 104, 110.

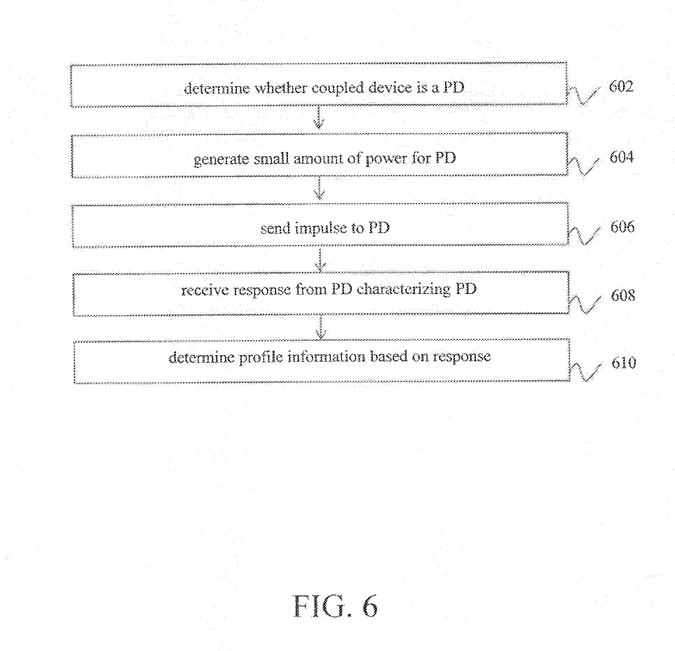

FIG. 6 is a flowchart of an exemplary method for active auto-negotiation in accordance with an embodiment of the present disclosure. In step 602, the PSE 102 determines whether the PD 106 qualifies as a PD. If the PSE 102 determines that the PD 106 does not qualify as a PD, the PSE 102 can stop trying to classify the PD and/or, in an embodiment, determine that power should not be supplied.

In step 604, once the PSE 102 determines that the PD 106 qualifies as a PD, the PSE 102 generates a minimal amount of power over the conductors 104, 110 to activate the PD 106. Once the PD 106 is active, the PD 106 can respond to impulses generated by the PSE 102 based on its profile information 302. In step 606, the PSE 102 generates an impulse to the PD 106. In an exemplary embodiment, the PD 106 can be configured to respond with information characterizing the PD 106 for all variations of possible auto-negotiation for PoE applications. In step 608, the PSE 102 receives the response from the PD 106. In step 610, based on the responses from the PD 106, the PSE 102 can generate a profile characterizing the PD 106 and can determine how to configure the power to be applied and/or the data communication over the conductors 104, 110.

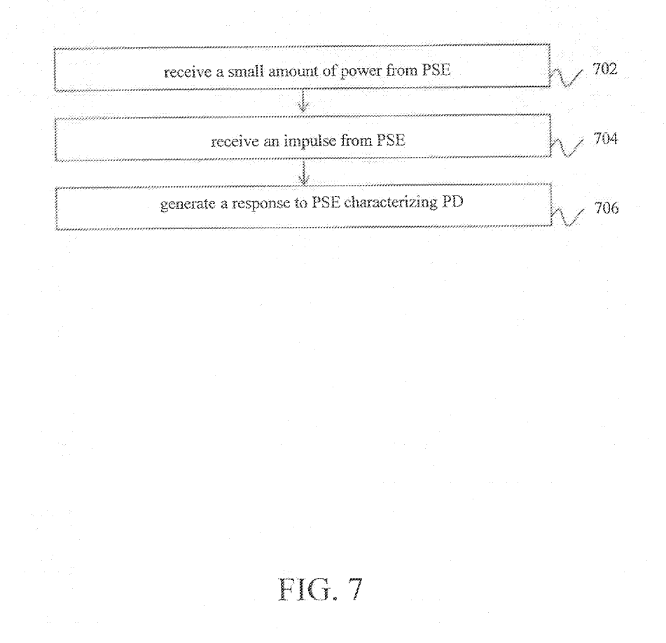

FIG. 7 is a flowchart of an exemplary method for active auto-negotiation performed by the PD 106 in accordance with an embodiment of the present disclosure. In step 702, the PD 106 receives a minimal amount of power over the conductors 104, 110 to activate the PD 106. Once the PD 106 is active, the PD 106 can respond to impulses generated by the PSE 102 based on its profile information 302. In step 704, the PD 106 receives an impulse from the PSE 102. In an exemplary embodiment, the PD 106 can be configured to respond to the impulse with information characterizing the PD 106 for all variations of possible auto-negotiation for PoE applications. In step 706, the PD 106 generates a response to the PSE 102 based on the impulse that characterizes the PD 106. Based on the responses from the PD 106, the PSE 102 can generate a profile characterizing the PD 106 and can determine how to configure the power to be applied and/or the data communication over the conductors 104, 110.

### 6. CONCLUSION

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus the present disclosure should not be limited by any of the above-described exemplary embodiments.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Any representative signal processing functions described herein can be implemented in hardware, software, or some combination thereof. For instance, signal processing functions can be implemented using computer processors, computer logic, application specific circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented as a computer program executing on a machine, as a computer program product, or as a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g. software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, and further the invention should be defined only in accordance with the following claims and their equivalents.

What is claimed is:

1. A Power over Ethernet (PoE) system, comprising:
a communication port; and
a power source equipment (PSE) controller coupled to the communication port, wherein the PSE controller is configured to:
determine whether a device coupled to the communication port qualifies as a powered device,
send an impulse to the device, wherein the impulse is configured to cause the device to respond with information characterizing the device,
receive a response from the device, and
determine, based on the response, profile information for the device.

2. The PoE system of claim 1, wherein the PSE controller is further configured to:
determine, based on the profile information, how to configure power to be applied to the device over the communication port.

3. The PoE system of claim 1, wherein the impulse is configured to cause the device to respond with the information characterizing the device for a plurality of variations of possible auto-negotiation for PoE applications.

4. The PoE system of claim 1, wherein the PSE controller is further configured to:
generate an amount of power to power the device without causing damage to the device.

5. The PoE system of claim 1, wherein the PSE controller is further configured to:
determine, based on the response, a supported PoE standard of the device.

6. The PoE system of claim 1, wherein the communication port is coupled to a plurality of communication links, and wherein the PSE controller is further configured to:
determine, based on the response, whether the device is capable of operating in a two-pair or a four-pair configuration for transferring power; and
determine, based on the response, which communication links should be used for transferring power or communicating data to the device.

7. The PoE system of claim 1, wherein the PSE controller is further configured to:
determine, based on the response, a coding scheme for data communication that is supported by the device.

8. The PoE system of claim 1, wherein the PSE controller is further configured to:
determine, based on the response, a data rate for data communication that is supported by the device.

9. The PoE system of claim 1, wherein the PSE controller is further configured to:
determine, based on the response, noise sensitivity information of the device.

10. The PoE system of claim 1, wherein the PSE controller is further configured to:
determine, based on the response, an operational environment of the device.

11. A Power over Ethernet (PoE) system, comprising:
a communication port; and
a powered device (PD) controller coupled to the communication port, wherein the PD controller is configured to:
receive an impulse from a power source equipment (PSE) controller, wherein the impulse is configured to cause the PD controller to respond with information characterizing the PD controller for a plurality of variations of possible auto-negotiation for PoE applications, and
generate, based on the impulse, a response to the PSE controller, wherein the response contains profile information for the PD controller.

12. The PoE system of claim 11, wherein the profile information instructs the PSE controller how to configure power to be applied to the PD controller over the communication port.

13. The PoE system of claim 1, wherein the PD controller is further configured to:
receive an amount of power from the PSE controller to power the PD controller without causing damage to the PD controller.

14. The PoE system of claim 11, wherein the profile information contains information regarding a supported PoE standard of the PD controller.

15. The PoE system of claim 11, wherein the communication port is coupled to a plurality of communication links, and wherein the profile information contains information regarding:
whether the PD controller is capable of operating in a two-pair or a four-pair configuration for transferring power, and
which communication links should be used for transferring power or communicating data to the PD controller.

16. The PoE system of claim 11, wherein the profile information contains information regarding:
a coding scheme for data communication that is supported by the PD controller.

17. The PoE system of claim 11, wherein the profile information contains information regarding:
a data rate for data communication that is supported by the PD controller,
noise sensitivity information of the PD controller; and
an operational environment of the PD controller.

18. A method for auto-negotiation in a Power over Ethernet (PoE) system, the method comprising:
determining whether a device qualifies as a powered device;
sending an impulse to the device, wherein the impulse is configured to cause the device to respond with information characterizing the device for a plurality of variations of possible auto-negotiation for PoE applications;
receiving a response from the device;
determining, based on the response, profile information for the device; and
determining, based on the profile information, how to configure power to be applied to the device.

19. The method of claim 19, further comprising:
determining, based on the response, a supported PoE standard of the device.

20. The method of claim 19, further comprising:
determining, based on the response, whether the device is capable of operating in a two-pair or a four-pair configuration for transferring power,
determining, based on the response, a communication link to be used for transferring power or communicating data to the device;
determining, based on the response, a coding scheme for data communication that is supported by the device;
determining, based on the response, a data rate for data communication that is supported by the device;
determining, based on the response, noise sensitivity information of the device; and
determining, based on the response, an operational environment of the device.
